(19) United States
(12) Patent Application Publication
(10) Pub. No.: US 2025/0327947 A1
(43) Pub. Date: Oct. 23, 2025

(54) RECONFIGURABLE OPTICAL FILTER USING NONLOCAL METASURFACES

(71) Applicant: CORNING INCORPORATED, CORNING, NY (US)

(72) Inventor: Michael John Yadlowsky, Sunnyvale, CA (US)

(21) Appl. No.: 19/176,474

(22) Filed: Apr. 11, 2025

Related U.S. Application Data
(60) Provisional application No. 63/634,971, filed on Apr. 17, 2024.

(51) Int. Cl. G02B 1/00; G02B 5/20; G02B 27/30

(52) U.S. Cl. CPC G02B 1/002; G02B 5/201; G02B 27/30

(57) ABSTRACT

An optical component can include a substrate. The optical component can further include metasurface elements formed on a side of the substrate. Each metasurface element can provide a wavelength-selective filter, with at least two metasurface elements configured to filter different wavelengths. At least one of the metasurface elements can be comprised of a non-local metamaterial.

### CROSS-REFERENCE TO RELATED APPLICATIONS

This application claims the benefit of priority under 35 U.S.C. § 119 of U.S. Provisional Application Ser. No. 63/634,971 filed on Apr. 17, 2024, the content of which is relied upon and incorporated herein by reference in its entirety.

### FIELD OF THE DISCLOSURE

The present disclosure relates generally to reconfigurable control of wavelength filtering of an optical or electromagnetic signal.

### BACKGROUND OF THE DISCLOSURE

Most optical components in use today have properties set at the time of manufacture. There is an ongoing effort to develop components that can be used across a wider range of use cases.

### SUMMARY

In an example, a component can include: a substrate and a plurality of metasurface or metamaterial elements formed on one or both sides of the substrate. A metasurface element of the plurality can provide a wavelength-selective filter. At least two metasurface elements of the plurality of can filter different wavelengths. At least one of the metamaterial elements can comprise a non-local metamaterial.

In an example, a device can include an optical component. The optical component can comprise a substrate and a plurality of metasurface elements formed on one or both sides of the substrate. A metasurface element of the plurality can provide a wavelength-selective filter. At least two metasurface elements of the plurality of can filter different wavelengths. At least one of the metasurface elements can comprise a non-local metamaterial. The device can include a first actuator configured to move the substrate along a first axis relative to an illumination source such that light from the illumination source passes through a selected metasurface element of the plurality of metasurface elements.

In an example, a method can include providing a substrate and forming a plurality of metasurface elements on a side of the substrate. At least two metasurface elements of the plurality of metasurface elements can provide wavelength filters to filter two separate wavelengths. The method can include moving the substrate along a first axis relative to a signal source such that a signal from the signal source passes through a selected metasurface element of the plurality of metasurface elements.

### BRIEF DESCRIPTION OF THE DRAWINGS

FIG. 1A-1D illustrates the schematic of a wavelength add/drop filter.

FIG. 2 illustrates a component in accordance with some embodiments.

FIG. 3 illustrates a device in accordance with some embodiments.

FIG. 4 illustrates a second configuration of a component in accordance with some embodiments.

FIG. 5 illustrates a device in accordance with some embodiments.

FIG. 6 illustrates a third configuration of a component in accordance with some embodiments.

FIG. 7 illustrates a device in accordance with some embodiments.

FIG. 8 illustrates a metasurface filter element according to some embodiments.

Corresponding reference characters indicate corresponding parts throughout the several views. Elements in the drawings are not necessarily drawn to scale. The configurations shown in the drawings are merely examples and should not be construed as limiting in any manner.

### DETAILED DESCRIPTION

An optical element can be fabricated by mounting components on an optical substrate or the like. Many optical elements, such as lenses, wavelength filters, polarizers, and diffractive optical elements, have fixed functional properties once they are fabricated.

There are many applications in which it would be beneficial to change some aspect of the optical system in response to the conditions under which the component is being used. For example, optical filters transmit light of different wavelengths, and it may be desirable to select different wavelengths depending on conditions or needs of the device.

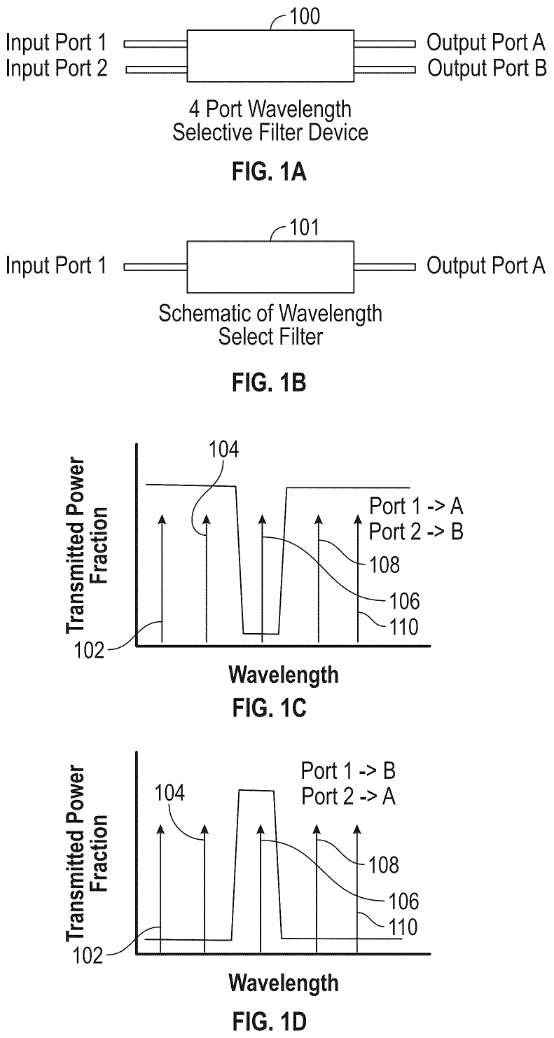

FIG. 1A illustrates the schematic of a wavelength add/drop filter 100 an example of the device constructed according to one embodiment of the disclosure. Filter 100 is shown with two input ports (Input port 1 and Input port 2) and two output ports (Output port A and Output port B). Input wavelengths at Input port 1 can either go straight through to Output port A or be filtered out by being re-routed to Output port B. Referring to FIG. 1B as an example, given five wavelengths 102, 104, 106, 108, 110, wavelength 106 can be filtered out by re-routing to Input port 2 which is provided to Output port B. The other four wavelengths 102, 104, 108, 110 remain unfiltered and provided to Output port A. As an additional example, referring to FIG. 1C as an example, given five wavelengths 102, 104, 106, 108, 110, wavelengths 102, 104, 108 and 110 can be filtered out by re-routing to Input port 2 which is provided to Output port B. The other wavelength 106 can remain unfiltered and provided to Output port A. While five wavelengths of a given bandwidth are shown, more or fewer wavelengths can be filtered or left unfiltered.

Wavelength-selective filters are used to multiplex and demultiplex wavelength channels in optical communication systems. In addition, wavelength-selective filters may be used to add and drop select wavelength channels at nodes in an optical communication network. Thin film filters made of multiple layers of thin (<1 wavelength) materials, typically alternating between high and low refractive index, can be used to provide rapid changes in transmission with relatively small changes in incidence wavelength and have been used in commercial systems to combine multiple optical channels with densely spaced carrier wavelengths e.g., 200 GHz, 100 GHz, or less.

If wavelength-selective filters were reconfigurable (e.g., if the transfer functions could be changed when needed), then less-complex systems and methods could be designed for managing connectivity and bandwidth in optical networks. Furthermore, fewer separate parts could be required, since one reconfigurable part could be used to provide filters appropriate for selecting multiple wavelengths. However, reconfigurable filter technologies available today suffer from various deficiencies.

Thin film wavelength filters can be “tuned” to change the wavelength at which they operate by tilting the filter element with respect to the incident beam. However, as the angle of incidence of the optical beam relative to the filter element changes, the shape of the transfer function corresponding to the transmitted and reflected spectra change and other properties such as polarization dependent loss increase and thus degrade the filter performance. As a result, the maximum tuning range of angle-tuned thin film filters is limited.

Multiple thin film filters are typically fabricated on a common wafer or substrate and singulated, “diced” or cut into individual filter elements. Internal stresses and mismatches in the mechanical properties or state of the substrate and individual layers frequently causes the transfer function of a diced thin film filter element to vary with transverse spatial coordinate. In addition to limiting the optical performance of the device, this puts a lower limit on the practical size of the filter element.

Bragg gratings can be fabricated in optical fiber, and these can be used as wavelength add or drop filters. Furthermore, their center wavelength can be tuned by e.g., stretching the optical fiber. However, this also provides a limited tuning range because of concerns about decreasing the reliability of the fiber due to large amounts of induced strain or possible changes in the shape of the filter transfer function as its center wavelength is tuned a greater range.

Components and devices according to embodiments address these concerns by providing metasurface elements or wave processing elements with compact cross sections. The small size allows the device to support an increased number of addressable wavelengths while maintaining a compact size and simplifying mechanical actuation. Further with respect to use with optical fibers or other waveguides, the ability to incorporate the optical power needed to efficiently focus light back into the optical fibers or waveguides provides the potential for further cost savings through the reduction in number of components needed.

Local metasurfaces provide spatial control of optical/electromagnetic waves such as optical power to focus beams. Local metasurfaces can be formed with sub-wavelength pillars whose diameters can be modified to provide a local phase delay of the electromagnetic wave that can span a range of 0 to 2 π around an arbitrary fixed value. Other structures can also be used to achieve other design objectives such as improving throughput.

Frequency dependent transfer functions that provide filter functionality can be implemented with non-local metasurfaces. Non-local metasurfaces can be implemented with photonic crystal slabs, guided mode resonances, etc. In contrast to local metasurfaces, non-local metasurfaces provide a resonance, storage, or dwell time within the structure. Adding absorption to a non-local metasurface using a guided mode resonance allows independent control of the spectral properties of the filter element at different wavelengths. In other words, in contrast with local metasurfaces, a spatial mixing of input electromagnetic fields can occur with non-local metasurfaces. This gives non-local metasurface structures a spectral or wavelength domain dependence.

Apparatuses and devices according to embodiments use a set of fixed non-local metasurface filter elements. An actuator or motor can move the filter elements relative to the optical path of one or more light paths to create a reconfigurable filter or add/drop multiplexer. The use of fixed filter elements based on non-local metasurfaces each optimized for a different wavelength can provide a more well-defined transfer function than a continuously tunable filter while the mechanical alignment tolerances of the device are also relaxed relative to continuously tunable device.

Metasurface filter elements initially showed relatively weak spectral dependence compared to thin film filters due to the modest resonances that can be achieved. However, designs that include non-local metasurfaces, whose transfer function depends on the momentum vector or angle of incidence of the light onto the device, provide greater wavelength selectivity.

Filters based on metamaterials/metasurfaces can be designed and fabricated to be of small cross-section (e.g., <1 mm×<1 mm to 5-10 mm×5-10 mm millimeters) and multiple filter elements can be positioned near each other thus producing arrays or other structures. Metasurface filters can be patterned into small cross-section more easily than thin film filters, which are typically patterned in layers across a wafer or other substrate.

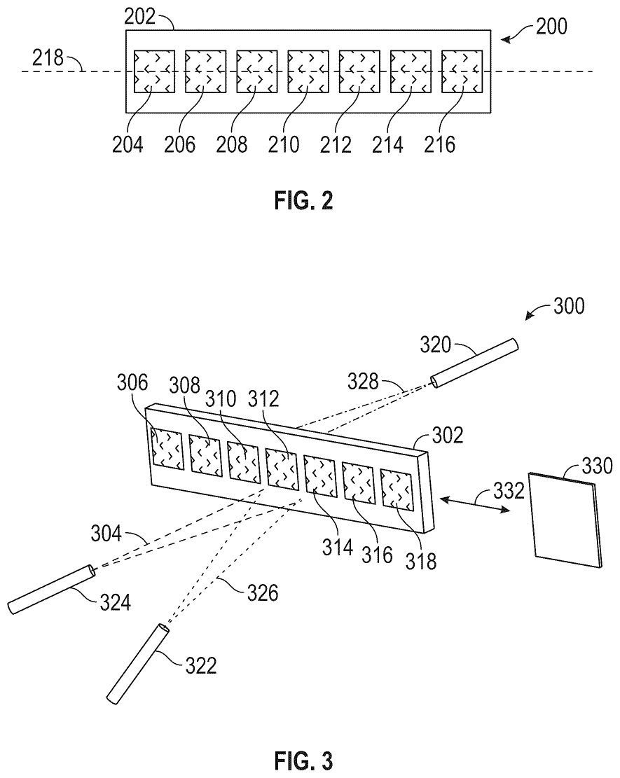

FIG. 2 illustrates a component 200 in accordance with some embodiments. The component 200 can include a substrate 202 and a plurality of metasurface elements 204, 206, 208, 210, 212, 214, 216 formed on at least one side of the substrate 202. The plurality of metasurface elements 204, 206, 208, 210, 212, 214, 216 can provide a wavelength-selective transmission and reflection of optical radiation. The wavelength selective filter elements consist of metasurfaces. Non-local metasurfaces are known in the art and provide greater flexibility to control the transmission and reflection spectra of the filter elements compared to earlier metasurfaces which were closer to being local, that is not having a wavelength-dependent energy storing resonance within the structure. In examples, at least two metasurface elements 204, 206, 208, 210, 212, 214, 216 can filter different wavelengths from each other, and in examples all of the metasurface elements 204, 206, 208, 210, 212, 214, 216 can filter different wavelengths.

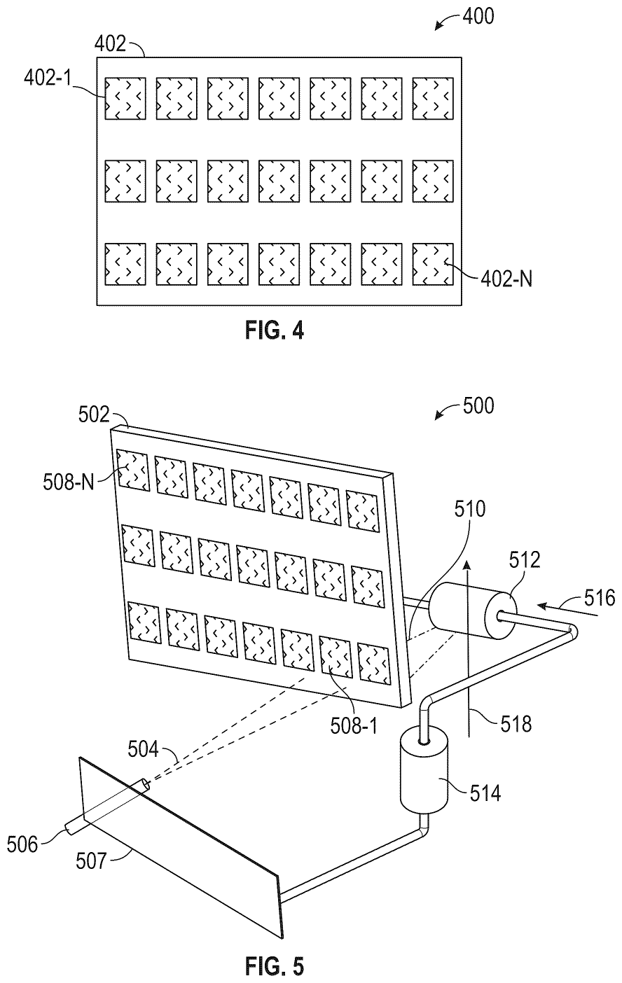

The metasurface elements 204, 206, 208, 210, 212, 214, 216 can be arranged in an array along the substrate such that the elements 204, 206, 208, 210, 212, 214, 216 are all spaced a distance from each other. The metasurface elements 204, 206, 208, 210, 212, 214, 216 can be spaced along an axis 218 in a first dimension. Other configurations are described below with respect to FIG. 4-6.

Metasurface elements 204, 206, 208, 210, 212, 214, 216 can include subwavelength-spaced arrays of nanostructures. The nanostructures can control the phase, amplitude, and polarization of light with very high spatial resolution, such as less than a wavelength. In some examples, each nanostructure can have a value of birefringence and an orientation, with the values of birefringence and the orientations varying from nanostructure to nanostructure. In some examples, the metasurface elements can include multiple layers of nanostructures, so that incident light passes through a first layer of nanostructures, then passes through a second layer of nanostructures, and so forth. In some examples, two or more layers can be formed directly upon one another.

Each metasurface element 204, 206, 208, 210, 212, 214, 216 can comprise a wavelength-selective filter element comprised of sub-wavelength structures, in particular non-local metamaterials (which may provide guided-mode resonance). However, not all metasurface elements 204, 206, 208, 210, 212, 214, 216 necessarily comprise non-local metamaterials and some subset of metasurface elements 204, 206, 208, 210, 212, 214, 216 may comprise local metamaterials.

The dimensions and/or geometry of the nanostructures can vary from nanostructure to nanostructure. Metasurface elements can provide multiple optical functions on a single metasurface element and can be fabricated relatively easily using conventional manufacturing techniques. For example, a top-down approach for forming a metasurface element can include growing a thin film on a substrate, coating the thin film with photoresist, using lithography to define features (using e-beam, photolithography, and/or nanoimprint techniques), etching around the features, adding cladding material, and adding an optional reflective layer (such as a metal layer). As another example, a bottom-up approach forming a metasurface element can include coating photoresist on a substrate, using lithography to define features in the photoresist, growing a thin film on the photoresist, lifting the thin film off (which can remove all but the defined features), adding a cladding material, and adding an optional reflective layer (such as a metal layer). Other suitable design and manufacturing techniques can also be used. For fabrication of metasurface elements that include multiple layers of nanostructures, either the top-down approach and/or bottom-up approach can be repeated per layer of nanostructures.

FIG. 3 illustrates a device 300 in accordance with some embodiments. Devices according to embodiments provide a reconfigurable filter device in which the transfer function corresponding to one or more ports (see e.g., FIG. 1) can be changed by moving filter element 302 relative to the path 304 of an optical (or other electromagnetic) signal as shown below. Metasurfaces 306, 308, 310, 312, 314, 316, 318 provide a structure that can implement methods for managing an optical path such as implementing a lens function to focus the light from the filter element into the transmission output fiber 320 or the reflection output fiber 322 as well as providing the wavelength-selective transfer function needed to do the filtering. However, to simplify the design of the filter element, the device 300 can also be made with optional collimating lens elements associated with each fiber 324, 322, 320 port.

The component 302 can be similar to the component described above with respect to FIG. 1. Incident light 304 can be provided from the signal coupling element 324 (which can include optical fiber or a free space beam). A reflected beam can be generated to converge to fiber 322 if optical focusing power is included in the metasurface element (e.g., element 312). Wavelengths that were filtered out (by e.g., the element 312) would be present in reflected beam 326. A transmitted beam 328 can converge to the fiber 320 for designs that include optical power in the corresponding filter element (e.g., element 312).

The device 300 can include an actuator 330 configured to move the substrate along a first axis 332 relative to a signal coupling element 324. The actuator 330 can comprise a stepper motor, MEMs flexure drive, or other component capable of moving the element 202 along one or more axes. Additional configurations are described below with reference to FIGS. 4-6.

FIG. 4 illustrates a second configuration of a component 400 in accordance with some embodiments. Similar to the component 200 (FIG. 2) the 400 can include a substrate 402 and a plurality of metasurface elements arranged in an array (or other pattern) of metasurface elements 402-1 through 402-N implementing the same function (e.g., wavelength filtering) but with different parameters such as different wavelength selectivity. The component 400 can include a greater number of metasurface elements 402-1 through 402-N than component 200 (FIG. 2). For example, the component 400 can include a number of rows of metasurface elements.

As shown in FIG. 5, the component 400 can also provide greater variation and options for displacement of the array. FIG. 5 illustrates a device 500 in accordance with some embodiments. The device 500 can include a component 502 like the component described above with respect to FIG. 4. Incident light 504 can be provided from the signal coupling element 506 (which can include optical fiber or a free space beam). A component housing 507 can be mechanically coupled to the incident beam, and the component housing 507 can include, for example, input fiber for optical fiber-coupled device. The signal can pass through a selected metasurface element 508-1 of the plurality of metasurface elements 508-1 through 508-N.

The device 500 therefore provides a reconfigurable optical component using an array of metasurface wave processing elements 508-1 through 508-N. A beam 510 can be transmitted from the device 500 for metasurface elements 508-1 through 508-N that operate in transmission. Converging functionality of a lens can be included in elements 508-1 through 508-N to direct light into a fiber without the need for additional components.

The device 500 can include one or more actuators 512, 514 configured to move the substrate along a first axis 516 and or additional axes 518 relative (e.g., perpendicular) to the signal coupling element 506. The metasurface element array (including elements 508-1 through 508-N) can be translated relative to incident optical beam (or component housing 507 thereof) to change optical component function. The actuator/s 512, 514 can comprise a stepper motor, MEMs flexure drive, or other component capable of moving the element 502 along one or more axes.

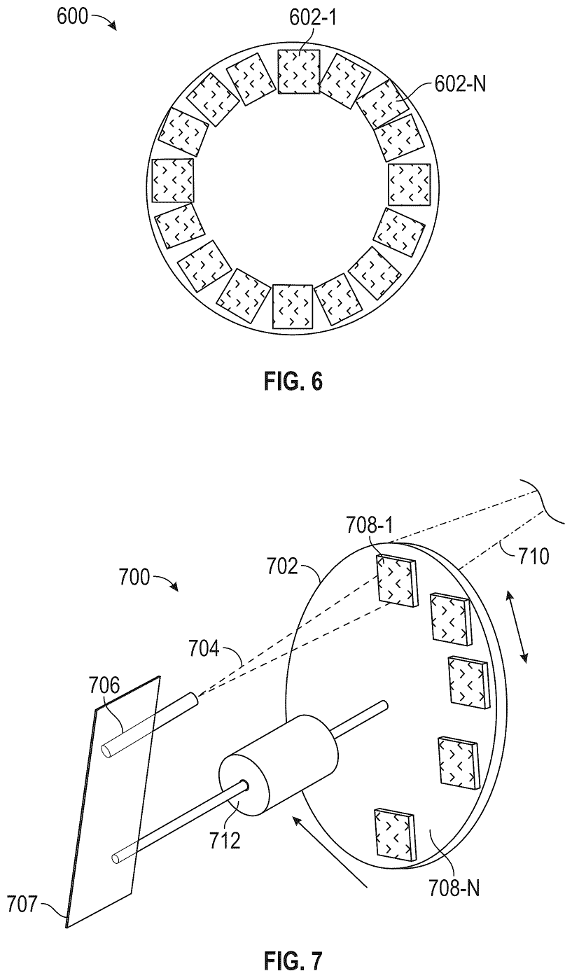

FIG. 6 illustrates a third configuration of a component 600 in accordance with some embodiments. Similar to the component 200 (FIG. 2) and component 400 (FIG. 4) the component 600 can include a substrate and a plurality of metasurface elements arranged in a circular pattern (e.g., around a circumference or part of a circumference of a circular, elliptical, oval, or other geometric shape) of metasurface elements 602-1 through 602-N implementing the same function (e.g., lens) but with different parameters such as wavelength selectivity.

As shown in FIG. 7, the component 600 can provide different variations for displacement of the array. FIG. 7 illustrates a device 700 in accordance with some embodiments. The device 700 can include a component 702 like the component described above with respect to FIG. 6. Incident light 704 can be provided from the signal coupling element 706 (which can include optical fiber or a free space beam). A component housing 707 can be mechanically coupled to the incident beam, and the component housing 707 can include, for example, input fiber for optical fiber-coupled device. The signal can pass through a selected metasurface element 708-1 of the plurality of metasurface elements 708-1 through 708-N.

The device 700 therefore provides a reconfigurable optical component using an array of metasurface wave processing elements 708-1 through 708-N. A beam 710 can be transmitted from the device 700 for metasurface elements 708-1 through 708-N that operate in transmission. Converging functionality of a lens can be included in elements 708-1 through 708-N to direct light into a fiber without the need for additional components.

The device 700 can include at least one actuator 710 configured to rotate the substrate relative to incident optical beam (or component housing 707 thereof) to change optical component function. The actuator 712 can comprise a stepper motor, MEMs flexure drive, or other component capable of moving the element 702. In some examples, while the device 700 may take up more space in a system compared to devices 300 and 500, actuators for the device 700 may be relatively simple and require less precision than for devices 300 and 500.

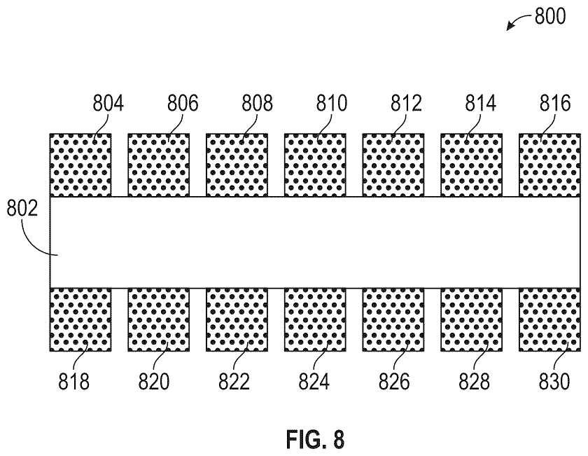

FIG. 8 illustrates the cross-section of a filter element 800 having metasurfaces on both sides of a substrate 802. For example, any of the nanostructures described above with respect to non-local or local metasurfaces can be provided on both sides of the substrate 802. For example, pillars 804, 806, 808, 810, 812, 814, 816 can be provided on a first side of the substrate 802. Pillars 818, 820, 822, 824, 826, 828, 830 can be provided on an opposite side of the substrate 802. The nanostructures shown can be of any size or shape and are not necessarily of the same size and shape within a single filter element 800.

What is claimed is:

1. An optical component, comprising:
a substrate; and
a plurality of metasurface elements formed on one or both sides of the substrate, a metasurface element of the plurality configured to provide a wavelength-selective filter, at least two metasurface elements of the plurality of metasurface elements configured to filter different wavelengths, and at least one of the metasurface elements comprises a non-local metamaterial.

2. The optical component of claim 1, wherein each metasurface element includes a plurality of nanostructures.

3. The optical component of claim 2, wherein different wavelength filter transfer functions are provided using different numbers or types of nanostructures within each respective metasurface element.

4. The optical component of claim 2, wherein the non-local metamaterial provides guided-mode resonance.

5. The optical component of claim 1, wherein the plurality of metasurface elements is spaced a distance from others of the plurality.

6. The optical component of claim 5, wherein the plurality of metasurface elements is spaced along an axis in a first dimension.

7. The optical component of claim 5, wherein the plurality of metasurface elements is arranged in at least two rows along a first axis and wherein within each row the plurality of metasurface elements is spaced apart from each other along a second axis perpendicular to the first axis.

8. The optical component of claim 5, wherein the plurality of metasurface elements is arranged around a circumference of a geometric shape.

9. An optical device comprising:
an optical component comprising:
a substrate; and
a plurality of metasurface elements formed on one or both side of the substrate, a metasurface element of the plurality configured to provide a wavelength-selective filter, at least two metasurface elements of the plurality of metasurface elements configured to filter different wavelengths, and at least one of the metasurface elements comprises a non-local metamaterial; and
a first actuator configured to move the substrate along a first axis relative to an illumination source such that light from the illumination source passes through a selected metasurface element of the plurality of metasurface elements.

10. The optical device of claim 9, further comprising a second actuator to move the substrate along a second axis relative to the illumination source.

11. The optical device of claim 9, wherein the plurality of metasurface elements is configured to provide filters at a variety of wavelengths.

12. The optical device of claim 11, wherein nano features within each of the plurality of metasurface elements are varied respective to others of the plurality of metasurface elements to provide filters at a variety of wavelengths.

13. The optical device of claim 9, wherein the actuator is configured to rotate the substrate.

14. The optical device of claim 9, wherein the illumination source comprises optical fiber, and wherein the device includes a lens for focusing light into a transmission output fiber of the optical device.

15. The optical device of claim 14, wherein the illumination source includes a collimating lens.

16. The optical device of claim 9, further comprising a reflection output fiber to receive at least one filtered wavelength of the optical device.

17. A method comprising:
providing an optical component substrate;
forming a plurality of metasurface elements on a side of the substrate, a metasurface element of the plurality configured to provide a wavelength-selective filter, at least two metasurface elements of the plurality of metasurface elements configured to filter different wavelengths, and at least one of the metasurface elements comprises a non-local metamaterial; and
moving the substrate along a first axis relative to an illumination source such that light from the illumination source passes through a selected metasurface element of the plurality of metasurface elements.

18. The method of claim 17, further comprising moving the substrate along a second axis relative to the illumination source.

19. The method of claim 17, wherein the plurality of metasurface elements is configured to provide filters at a variety of wavelengths, and wherein the method includes providing nano-features within each of the plurality of metasurface elements to provide filters at a variety of wavelengths.

20. The method of claim 17, wherein the moving includes rotating the substrate about an axis.
